(19) United States
(12) Patent Application Publication
(10) Pub. No.: US 2008/0092052 A1
(43) Pub. Date: Apr. 17, 2008

(54) METHOD AND SYSTEM FOR CUSTOMIZING MULTIPLE USER INTERFACES MAPPED TO FUNCTIONS

(75) Inventors: AJIT MATHEWS, PLANTATION, FL (US); JON GODSTON, CHICAGO, IL (US); STEVEN J. NOWLAN, SOUTH BARRINGTON, IL (US); CARLTON J. SPARRELL, MARBLEHEAD, MA (US); HOI L. YOUNG, LAKE VILLA, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/548,984

(22) Filed: Oct. 12, 2006

(51) Int. Cl. G06F 15/177

(52) U.S. Cl. 715/736

(57) ABSTRACT

A method (80) and system (90) of customizing multiple user interfaces mapped to functions can include receiving (82) a new user interface component, determining (85) if the new user interface component is received as a result of a user request or a service provider input, and setting (86) the new user interface component as a default user interface component when the new user interface component is received as the result of a user request or a service provider input. The method can further register (84) the new user interface component or components using a user interface manager. The method can also display (88) a representation of other available user interface schemes on the new user interface component. The method can display a representation of additional functionality and enable a transition to the additional functionality by selection of the representation of the additional functionality in the new user interface component.

### FIELD

This invention relates generally to user interfaces, and more particularly to a method and system of customizing user interfaces mapped to functions in a device.

### BACKGROUND

Service providers in the communication and entertainment industry seek to control at least some aspect of the customer experience. Cable mutli-service operators (MSOs) develop their own electronic programming guide (EPG), digital video recorder (DVR), and video-on-demand (VOD) applications with their own branding. Similarly, wireless carriers create look and feel guidelines for phone navigation, software and applications. At the same time, device vendors seek to create a uniform look and feel to establish brand identity and end users often desire to customize their own look and feel, or adopt affinity look and feel skins, such as NASCAR, Disney Kids, or ‘Hello Kitty’ for example. These dueling UI requirements create confusion for consumers and difficulties for UI designers.

Multiple user interfaces (UIs) or different skins are known in the multimedia art. Under current schemes, the skins or UI can be changed, but the functions and applications remain static. Existing schemes do not provide the flexibility to change the functionality and tailor the UIs or skins on a case by case basis where multiple user interfaces coexist that are mapped to different functions or interactive features.

### SUMMARY

Embodiments in accordance with the present invention can provide a method and system for allowing multiple user interfaces to coexist that further allows users to customize or choose which UI elements are mapped to certain interactive features. For example, a user may prefer a service provider's VOD screens while also preferring a device manufacturer's playback screens. A little more complex example can allow the user to have the presentation and the behavior aspects selectively customized from the available sources (device manufacturer, service provider, or user defined) to enable a flexible customized user experience on the device.

In a first embodiment of the present invention, a method of customizing multiple user interfaces mapped to functions can include the steps of receiving a new user interface component, determining if the new user interface component is received as a result of a user request or a service provider input, and setting the new user interface component as a default user interface component when the new user interface component is received as the result of a user request or a service provider input. The method can further include the step of registering the new user interface component or components using a user interface manager. The method can also display a representation of other available user interface schemes on the new user interface component. The method can display a representation of additional functionality with the new user interface component that was not available with a prior default user interface component and enable a transition to the additional functionality by selection of the representation of the additional functionality in the new user interface component. The method can also restrict the new user interface components to a predetermined set of transitions or functions or restrict the new user interface components to a set of certified components. The method can also enable a different set of user interface components for each user of a system or based on location or a host device that presents the new user interface component.

In a second embodiment of the present invention, a system of customizing multiple user interfaces mapped to functions can include a receiver for receiving a new user interface component and a processor coupled to the receiver. The processor can be programmed to determine if the new user interface component is received as a result of a user request or a service provider input and set the new user interface component as a default user interface component when the new user interface component is received as the result of a user request or a service provider input. The system can further include a user interface manager coupled to the processor that registers the new user interface component or components. The system can also include an application layer having a behavior specification independent of a presentation specification. The system can include an interaction management layer that generates and updates a presentation by processing user inputs and other external knowledge sources to determine an intent of a user. The system can also include an engine layer that converts information from the interaction management layer into higher level language comprehendible by users and that further captures natural inputs from users and translates such natural inputs into information useful by the interaction management layer. The system can also include a modality interface layer that provides an interface between the interaction management layer and the engine layer. Note, the processor can further be programmed to display a representation of additional functionality with the new user interface component that was not available with a prior default user interface component and further programmed to enable a transition to the additional functionality by selection of the representation of the additional functionality in the new user interface component. The processor can be further programmed to restrict the new user interface components to a predetermined set of transitions or functions.

In a third embodiment of the present invention, a communication device having customizable multiple user interfaces mapped to functions can include a receiver for receiving a new user interface component and a processor coupled to the receiver. The processor can be programmed to determine if the new user interface component is received as a result of a user request or a service provider input, set the new user interface component as a default user interface component when the new user interface component is received as the result of a user request or a service provider input, and display a representation of other available user interface schemes on the new user interface component for a predetermined functionality. The processor can be further programmed to display a representation of additional functionality with the new user interface component that was not available with a prior default user interface component. The processor can also be programmed to enable a transition to the additional functionality by selection of the representation of the additional functionality in the new user interface component.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing as well as a machine readable storage for causing a machine to perform the various processes and methods disclosed herein.

### BRIEF DESCRIPTION OF THE DRAWINGS

FIG. 1 is a block diagram of a partition of a user interface functionality in accordance with an embodiment of the present invention.

FIG. 2 is a screen display of a user interface in accordance with an embodiment of the present invention.

FIG. 3 is a GUI flow diagram showing a potential user navigation path through a user interface in accordance with an embodiment of the present invention.

FIG. 4 is a default user interface in accordance with an embodiment of the present invention.

FIG. 5 is an alternative user interface in accordance with and embodiment of the present invention.

FIG. 6 is a screen display of a user interface having a control for switching to another scheme in accordance with an embodiment of the present invention.

FIG. 7 is another screen display of another user interface embedded in a frame in accordance with an embodiment of the present invention.

FIG. 8 is flow diagram illustrating a method to allow multiple user interfaces to coexist and allow users to customize or choose which UI elements are mapped to certain interactive features in accordance with an embodiment of the present invention.

FIG. 9 is a block diagram of the architectural framework supporting the method of FIG. 8 in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways in various devices such as in personal digital assistants, cellular phones, laptop computers, desktop computers, digital video recorder, set-top boxes and the like. Generally speaking, pursuant to these various embodiments, a method or system herein can further extend the concept of user interfaces a skins by encapsulating a chosen primary skin/UI with a secondary (and or tertiary) UI or branding for example. Illustrative of such embodiments can include a ring or ring-tone of a manufacturer's choice within which the primary UI is rendered in a window of a service provider's choice. In another example, an alternative for a smaller scale GUI (e.g., for a mobile device) can be embedded as a graphical icon representing an alternative UI for the smaller scale GUI.

Each UI may have overlapping features (similar to existing skins that mimic behavior in different look and feel schemes) and non-overlapping features (e.g., phone settings can be limited to the device manufacturer UI, or the service provider can have service specific UI information). The user can swap between UIs by selecting the appropriate icon, menu, or haptic control. A user can have the ability to change UI representations as one would traditionally change a channel, or display mode in order to simplify the method of user personalization. In the past when users have been expected to select their profile or “login”, they usually don't bother, but making it simple will increase the likelihood that a user will select something other than a default UI. Since each skin or user interfaces may have different features, unique features between one UI and another may be highlighted when swapping or changing into a secondary UI. This can either be done automatically (on switching) or by selecting a ‘highlight differences’ button/menu item. A user can set defaults such that when certain UI screens to a particular feature, it automatically switches to the preferred GUI for that feature. A user might prefer the service provider's VOD screens, for example, and the device manufacturer's playback screens.

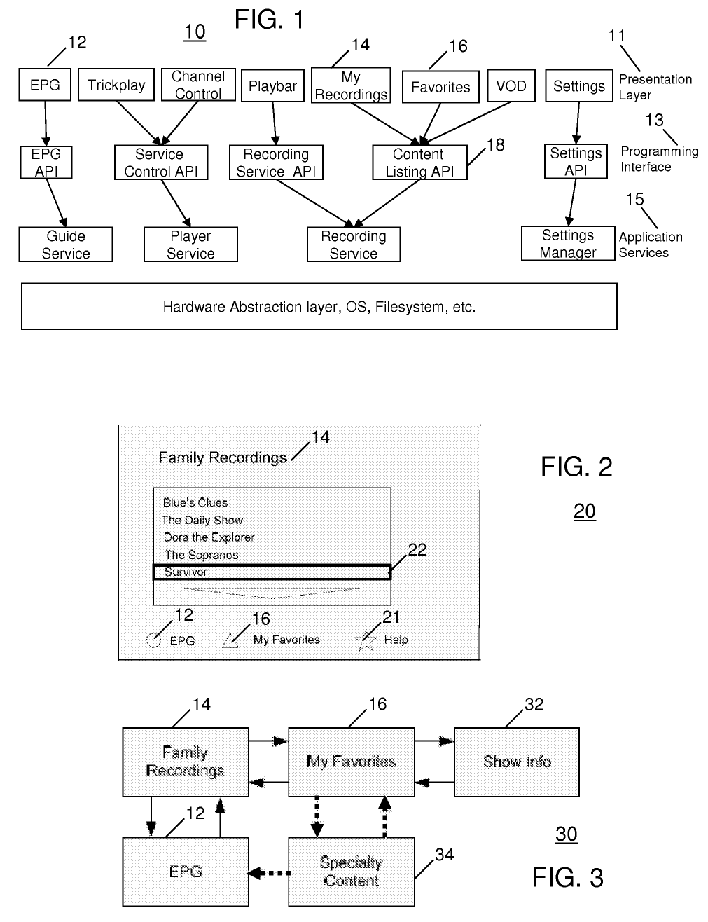

Referring to FIG. 1, a software stack or a block diagram of a user interface functionality partition 10 of an example embodiment for a Digital Video Recorder is illustrated. The graphical user interface or GUI consists of a number of screens, each navigable by a remote control. A top layer represents a presentation layer 11, a programming layer that provides the necessary logic to display and navigate through the GUI. The presentation layer 11 can be developed in Java using the AWT widget set, for example, or using a specialized graphical navigation and presentation tool such as Flash or Dynamic HTML (DHTML). Application services 15 provide the necessary logic for performing the DVR functionality such as a Recording Service that is responsible for scheduling recordings and providing a list of existing recordings. In one embodiment as shown, the presentation layer 11 accesses the application services 15 through a set of XML based Application Programming Interfaces (APIs) 13.

The presentation layer 11 illustrates a partition of the user interface functionality into several functional blocks. Each one of these blocks consists of one or more GUI screens. For example, FIG. 2 illustrates one possible screen 20 for a block 14 for My Recordings or Family Recordings displaying a list of previously recorded programs for the entire family. A user can scroll through the list of recordings and select a recording 22, or navigate to other functions (EPG 12, My Favorites 16, or Help 21) by using the remote control. In this example, certain functions can also be mapped to special remote control buttons specified by different colors or shapes. For example, the EPG function is a circle, the favorites function is a triangle, and the help function is a star.

Referring to FIG. 3, a GUI flow diagram 30 illustrates how a user might navigate through certain paths through a UI screen given the options on each screen. For example, from the Family Recordings page 14, the user might select the EPG screen 12 or the Favorites screen 16. From the favorites screen 16, a show info screen 32 can provide additional information or a specialty content screen 34 might provide access to additional or special content.

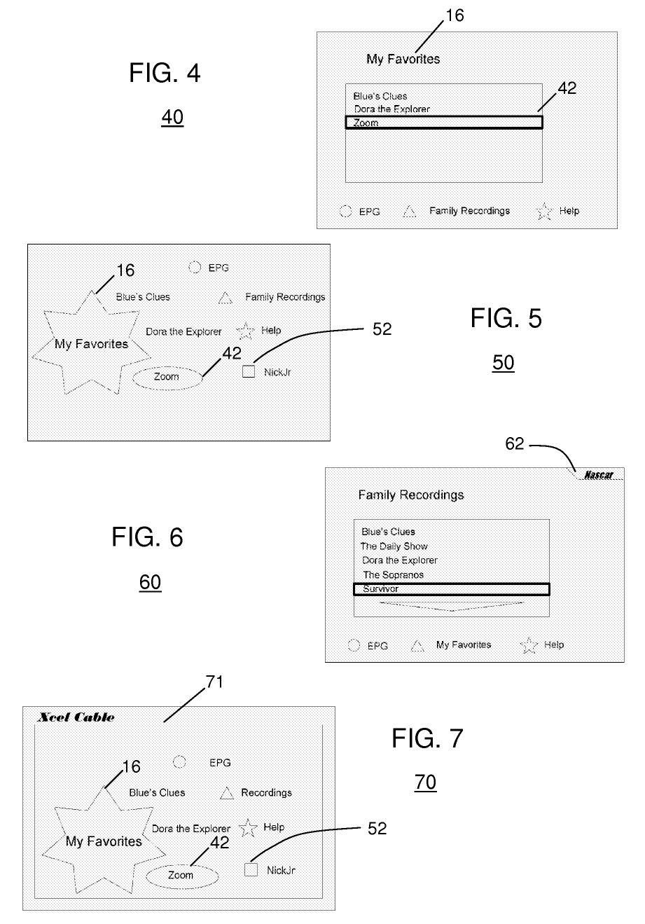

New or additional user interface presentation components can be installed and selected by either the provider or the user. A default Favorites screen 40, for example, as illustrated in FIG. 4 can include an icon 16 for My Favorites and a list of programming and can enable the selection of a recording 42 while a more fanciful interface screen 50 as illustrated in FIG. 5 can include not only a fanciful icon 16 for My Favorites, but also an additional button prompt 52 that may add functionality, such as bring the user to specific ‘Nick Jr.” VOD content (instead of a local pre-recorded program such as the recording 42 for zoom.

Each screen represents a certain core piece of functionality, with various transitions between that screen and other screens. Each screen can be represented as a functional component that upon installation registers with the system one or more of the following: interaction functionality, the Look and Feel scheme, UI calls, and transitions with other functional components. As a set, each component of the Look and Feel scheme may create an entire or a partial GUI. Each function can be ‘overloaded’, such that a given function or screen can be represented by more than one look and feel. A given component may also represent additional functionality, providing additional transitions to new features.

To provide a framework for components, and to provide some consistency with the user, one particular embodiment can restrict downloadable components to match a required set of transitions and/or functionalities. In an alternative embodiment, only certified components may be installed in the system.

A registration manager can be made responsible for tracking installed UI components. In one embodiment, a single UI component for each functionality is set as active. When a transition occurs between one UI function and another, the registration manager can indicate which component is instantiated next. If the user selects a different component for that function, the new component will be registered as default. In another embodiment, a different set of components will be selected for each user of the system. In another embodiment, a different set of components can be selected based on the room or location (using GPS or IP addressing for example) or based on the device on which the UI is displayed.

A user can select to change to a completely new look and feel, or to a different look and feel for one or more components. As described above, this also allows a new look and feel to be downloaded by the service provider, while the old UI components still exist in the background.

Referring to FIG. 6, a UI 60 that indicates an active UI component with one scheme and can further include a control 62 for switching to another scheme in the upper right hand corner. The graphics are designed to suggest the active UI screen in the foreground with another UI(s) in the background. In this case, a user navigating to the icon in the upper right corner can select the new UI scheme.

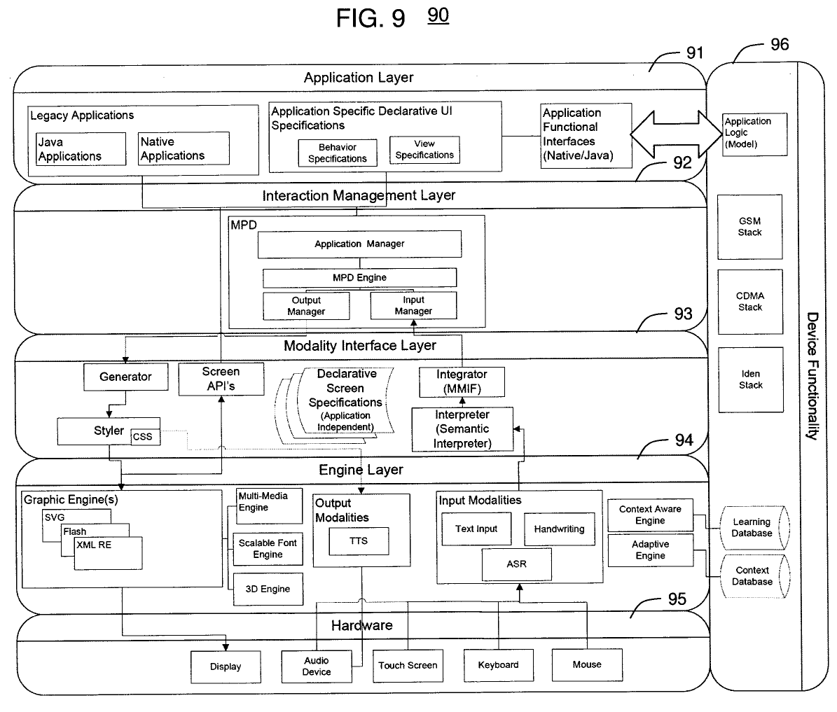

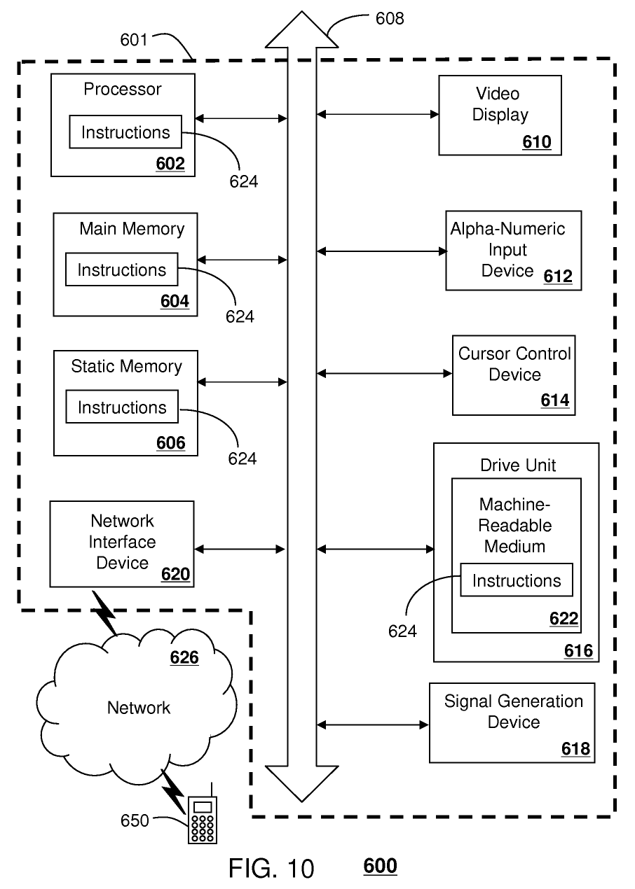

Referring to FIG. 7, another means for illustrating an optional UI scheme 70 is shown. In this case a new UI scheme is embedded in a frame 71, where the frame 71 preserves the branding of the default UI (similar to the UI 50 of FIG. 5). Here, the look and feel and branding of the default UI can be for cable operator. Note, the embodiments of FIGS. 1-7 in general relate to set-top boxes, but other embodiments are certainly within contemplation of the scope of the embodiments. For example, FIG. 9 illustrates a mobile phone having similar capabilities with respect to customizing user interfaces. Further note, some aspects described above are more particularly relevant to more public (shared) devices such as a set-top box, such as switching between “Junior's” UI and an adult UI. Also note, a set-top box (STB) would not likely have GSM, CDMA, and iDEN stacks as shown in FIG. 9, but may have a DSM-CC, DSG, and various IP LAN and WAN stacks instead. Similarly, a STB would likely have an IR/Remote interface, instead of touch screen interface.

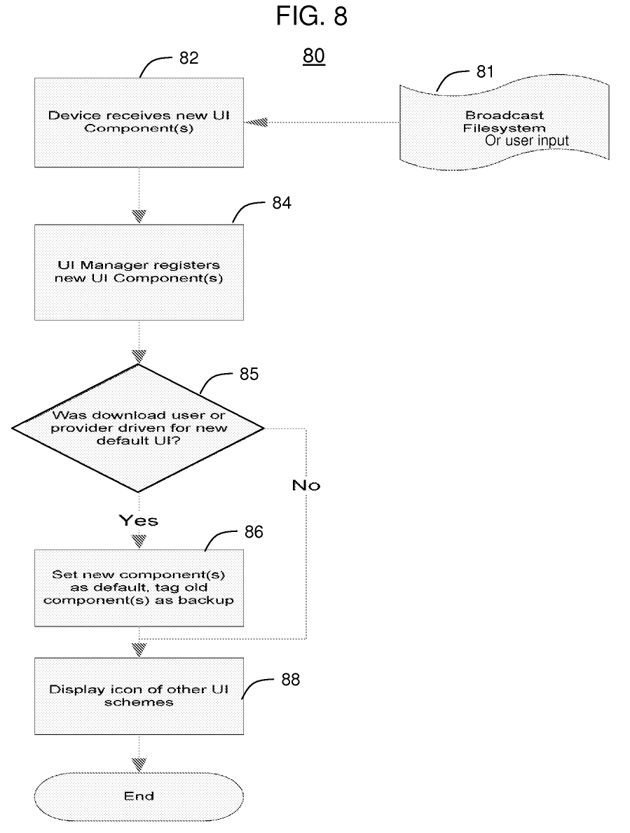

Referring to FIG. 8, a flow chart illustrates a method 80 of downloading a new UI scheme that either replaces the default UI, or is available as an optional UI. The flow chart illustrates how multiple user interfaces can coexist where users can customize or choose which UI elements to mapped to. At step 82, a new UI component or components are received from the system, in this case the broadcast file system of the cable operator or from a user 81. The new component or components can be registered at step 84. This means that the functionality and transitions of the new component are compared against the existing components and the component is listed as an optional replacement for similar components.

At decision step 85, if the component was downloaded by the user or an operator with the intention that the new component would be the default UI, this component is set or tagged as the default at step 86 and displayed at step 86 the next time a transition is made to that function. If the component was not downloaded to be a new default at decision step 85, then step 86 is skipped. In either case, in embodiments where optional components are displayed as icons or in some other means, the icon list is updated, and where appropriate a new icon is displayed representing the new component.

Unlike existing skins and themes where the complete user interface is replaced with a new User Interface, embodiments herein allows the user to keep the user interface which the user prefers or is used to and enables the replacement of the user interface or user interface components that the user would like to remove. Hence bringing in a better user experience and flexibility. Note, each function can be ‘overloaded’, such that a given function or screen can be represented by more than one look and feel. A given component may also represent additional functionality, providing additional transitions to new features certain interactive features.

Referring to FIG. 9, an overall architecture 90 of the user experience framework which supports the method 80 is shown and can present an alternate user experience to the user depending on the environmental conditions the user is in. The architecture 90 can include multiple layers including an application layer 91, an interaction management layer 92, a modality interface layer 93, an engine layer 94, a hardware layer 95 as well as a device functionality layer 96.

The application layer 91 has the clean separation of the Behavior and the Presentation specifications. That means the application behavior can be changed separately from the presentation specifications and vice versa. This is very important aspect of this framework for enabling the sharing of the user experience and the ability to change the user experience dynamically (based on environmentally driven policies).

The Interaction management layer 92 is responsible for generating and updating the presentation by processing user inputs and possibly other external knowledge sources (for example a Learning engine or Context Manager) to determine the intent of the user.

The Modality Interface Layer 93 provides an interface between semantic representations of input/output (I/O) processed by the Interaction Management layer 92 and modality specifics of I/O content representations processed by the Engine Layer 94.

The Engine layer 94 performs output processing by converting the information from the styling component (in the Interaction Management Layer 92) into a format that is easily understood by the user. For example, a graphics engine displays a vector of points as a curved line, and a speech synthesis system converts text into synthesized voice. For input processing, the engine layer 94 captures natural input from the user and translates the input into a form useful for later processing. The engine layer 94 can include a rule based learning engine and context aware engine. The engine layer 94 can provide outputs to the hardware layer 95 and can receive inputs from the hardware layer 95.

The Device Functionality layer 96 interfaces with the device specific services such as CDMA stack, Database etc. Such architecture can have a clean separation of the device functionality from the application and enable cleanly structured application data independent of device functionality.

FIG. 10 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 601 and a sending device 650 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 can include a controller or processor 602 (e.g., a central processing unit (CPU), a graphics processing unit (GPU, or both), a main memory 604 and a static memory 606, which communicate with each other via a bus 608. The computer system 600 may further include a presentation device such as a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control that can also serve as a presentation device) and a network interface device 620. Of course, in the embodiments disclosed, many of these items are optional.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of customizing multiple user interfaces mapped to functions, comprising the steps of:
receiving a new user interface component;
determining if the new user interface component is received as a result of a user request or a service provider input; and
setting the new user interface component as a default user interface component when the new user interface component is received as the result of a user request or a service provider input.

2. The method of claim 1, wherein the method further comprises the step of registering the new user interface component or components using a user interface manager.

3. The method of claim 1, wherein the method further comprises the step of displaying a representation of other available user interface schemes on the new user interface component.

4. The method of claim 1, wherein the method further comprises the step of displaying a representation of additional functionality with the new user interface component that was not available with a prior default user interface component.

5. The method of claim 4, wherein the method further comprises the step of enabling a transition to the additional functionality by selection of the representation of the additional functionality in the new user interface component.

6. The method of claim 1, wherein the method further comprises the step of restricting the new user interface components to a predetermined set of transitions or functions.

7. The method of claim 1, wherein the method further comprises the step of restricting the new user interface components to a set of certified components.

8. The method of claim 1, wherein the method further comprises the step of enabling the different set of user interface components for each user of a system.

9. The method of claim 1, wherein the method further comprises the step of selecting a different set of user interface components based on location or host device presenting the new user interface component.

10. A system of customizing multiple user interfaces mapped to functions, comprising:
a receiver for receiving a new user interface component; and
a processor coupled to the receiver, wherein the processor is programmed to:
determine if the new user interface component is received as a result of a user request or a service provider input; and
set the new user interface component as a default user interface component when the new user interface component is received as the result of a user request or a service provider input.

11. The system of claim 10, wherein the system further comprises a user interface manager coupled to the processor that registers the new user interface component or components.

12. The system of claim 10, wherein the system further comprises an application layer having a behavior specification independent of a presentation specification.

13. The system of claim 12, wherein the system further comprises an interaction management layer that generates and updates a presentation by processing user inputs and other external knowledge sources to determine an intent of a user.

14. The system of claim 13, wherein the system further comprises an engine layer that converts information from the interaction management layer into higher level language comprehendible by users and that further captures natural inputs from users and translates such natural inputs into information useful by the interaction management layer.

15. The system of claim 14, wherein the system further comprises a modality interface layer that provides an interface between the interaction management layer and the engine layer.

16. The system of claim 10, wherein the processor is further programmed to display a representation of additional functionality with the new user interface component that was not available with a prior default user interface component and further programmed to enable a transition to the additional functionality by selection of the representation of the additional functionality in the new user interface component.

17. The system of claim 10, wherein the processor is further programmed to restrict the new user interface components to a predetermined set of transitions or functions.

18. A communication device having customizable multiple user interfaces mapped to functions, comprising:
a receiver for receiving a new user interface component; and
a processor coupled to the receiver, wherein the processor is programmed to:
determine if the new user interface component is received as a result of a user request or a service provider input;
set the new user interface component as a default user interface component when the new user interface component is received as the result of a user request or a service provider input; and
display a representation of other available user interface schemes on the new user interface component for a predetermined functionality.

19. The communication device of claim 18, wherein the processor is further programmed to display a representation of additional functionality with the new user interface component that was not available with a prior default user interface component.

20. The communication device of claim 19, wherein the processor is further programmed to enable a transition to the additional functionality by selection of the representation of the additional functionality in the new user interface component.
